(19) United States
(12) Patent Application Publication
(10) Pub. No.: US 2025/0280195 A1
(43) Pub. Date: Sep. 4, 2025

(54) CONTROL METHOD AND APPARATUS OF ELECTRONIC DEVICE, TERMINAL, AND STORAGE MEDIUM

(71) Applicant: Beijing Zitiao Network Technology Co., Ltd., Beijing (CN)

(72) Inventors: Qingchuan HUANG, Beijing (CN); Guanghai FENG, Beijing (CN)

(21) Appl. No.: 19/067,063

(22) Filed: Feb. 28, 2025

(30) Foreign Application Priority Data
Mar. 1, 2024 (CN) 202410239959.4

(51) Int. Cl. H04N 23/60; H04N 23/20; H04N 23/56

(52) U.S. Cl. CPC H04N 23/665; H04N 23/20; H04N 23/56

(57) ABSTRACT

The present disclosure provides a control method and apparatus of an electronic device, a terminal, and a storage medium. The electronic device includes a sensor configured to determine whether the electronic device is in a wearing state, a camera configured to perform at least one of face tracking or eye tracking, and an infrared lamp configured to expose the camera. The control method of an electronic device includes: determining whether the camera is in an on state; based on determining that the camera is in an off state, reading data of the sensor according to a preset period to determine whether the electronic device is in the wearing state; and based on determining that the camera is in the on state, triggering generation and reading of the data of the sensor using an interrupt signal.

### CROSS-REFERENCE TO RELATED APPLICATION(S)

This application claims priority to Chinese Application No. 202410239959.4 filed on Mar. 1, 2024, the disclosure of which is incorporated herein by reference in its entirety.

### FIELD

The present disclosure relates to the field of information technology, and in particular, to a control method and apparatus of an electronic device, a terminal, and a storage medium.

### BACKGROUND

Virtual reality (VR) devices (for example, VR glasses) have been widely used in various fields, such as urban planning, industrial simulation, and historic site restoration. The VR device currently uses a proximity sensor (hereinafter referred to as Psensor) to determine whether the user wears the device. When the user wears the device, the value of the Psensor is greater than a proximity threshold, and then the user is determined to be in the wearing state, and then the screen is lit and the device starts working. Once the user takes off the device, the Psensor determines that the device is in the away state, the screen is turned off and the system is triggered to enter the sleep state, so as to implement the power-saving function.

Most Psensors emit infrared light in the form of pulses through infrared light-emitting diodes (IRLEDs), and detect infrared light reflected by an obstacle to determine whether there is an object approaching. Once infrared light in the same band exists in the working environment, the Psensor is prone to interference, resulting in abnormal function. Once the Psensor works abnormally, the device may be abnormally in the sleep state or awake, resulting in unusability. Therefore, further improvements in this regard are expected.

### SUMMARY

To solve the existing problems, the present disclosure provides a control method and apparatus of an electronic device, a terminal, and a storage medium.

The present disclosure adopts the following technical solutions.

An embodiment of the present disclosure provides a control method of an electronic device, the electronic device includes a sensor configured to determine whether the electronic device is in a wearing state, a camera configured to perform at least one of face tracking or eye tracking, and an infrared lamp configured to expose the camera, and the control method of an electronic device includes: determining whether the camera is in an on state; based on determining that the camera is in an off state, reading data of the sensor according to a preset period to determine whether the electronic device is in the wearing state; and based on determining that the camera is in the on state, triggering generation and reading of the data of the sensor using an interrupt signal.

Another embodiment of the present disclosure provides a control apparatus of an electronic device, the electronic device includes a sensor configured to determine whether the electronic device is in a wearing state, a camera configured to perform at least one of face tracking or eye tracking, and an infrared lamp configured to expose the camera, and the control apparatus of an electronic device includes: a state determination module configured to determine whether the camera is in an on state; a data reading module configured to, based on determining that the camera is in an off state, read data of the sensor according to a preset period to determine whether the electronic device is in the wearing state; and the data reading module is further configured to, based on determining that the camera is in the on state, trigger generation and reading of the data of the sensor using an interrupt signal.

In some embodiments, the present disclosure provides a terminal, including: at least one memory and at least one processor; the memory is configured to store program code, and the processor is configured to invoke the program code stored in the memory to perform the above-mentioned control method of an electronic device.

In some embodiments, the present disclosure provides a non-transitory computer-readable storage medium, the storage medium is configured to store program code, and the program code is configured to perform the above-mentioned control method of an electronic device.

According to the present disclosure, whether the camera is in the on state is determined, and the acquisition of the data of the sensor is determined based on the state of the camera, so that interference of the infrared lamp exposing the camera to the sensor can be avoided, the sensor can work reliably, and a good user experience is ensured while power consumption of the electronic device is saved.

### BRIEF DESCRIPTION OF THE DRAWINGS

The above and other features, advantages, and aspects of various embodiments of the present disclosure become more apparent with reference to the following specific embodiments and in conjunction with the drawings. Throughout the drawings, the same or similar reference numbers refer to the same or similar elements. It should be understood that the drawings are schematic and that the components and elements are not necessarily drawn to scale.

FIG. 1 is a schematic diagram of an electronic device according to an embodiment of the present disclosure.

FIG. 2 is a flowchart of a control method of an electronic device according to an embodiment of the present disclosure.

FIG. 3 illustrates a schematic diagram of the principle of a control method of an electronic device according to an embodiment of the present disclosure.

FIG. 4 illustrates a sequence diagram of some components of an electronic device according to an embodiment of the present disclosure.

FIG. 5 is a schematic flowchart of a control method of an electronic device according to an embodiment of the present disclosure.

FIG. 6 is a schematic flowchart of a control method of an electronic device according to an embodiment of the present disclosure.

FIG. 7 illustrates some modules of a control apparatus of an electronic device according to another embodiment of the present disclosure.

FIG. 8 is a schematic structural diagram of an electronic device according to an embodiment of the present disclosure.

### DETAILED DESCRIPTION

Embodiments of the present disclosure are described in more detail below with reference to the drawings. Although some embodiments of the present disclosure are shown in the drawings, it should be understood that the present disclosure may be implemented in various forms and should not be construed as limited to the embodiments set forth herein. On the contrary, these embodiments are provided for a more thorough and complete understanding of the present disclosure. It should be understood that the drawings and embodiments of the present disclosure are only for exemplary purposes, and are not intended to limit the protection scope of the present disclosure.

It should be understood that various steps described in method implementations of the present disclosure may be performed sequentially and/or in parallel. In addition, the method implementations may include additional steps and/or omit performing the illustrated steps. The scope of the present disclosure is not limited in this regard.

The term “include/include” and variations thereof as used herein are open-ended inclusions, that is, “include/include but not limited to”. The term “based on” is “based, at least in part, on”. The term “an embodiment” means “at least one embodiment”. The term “another embodiment” means “at least one additional embodiment”. The term “some embodiments” means “at least some embodiments”. Relevant definitions of other terms will be given in the description below.

It should be noted that concepts such as “first” and “second” mentioned in the present disclosure are only used to distinguish between different apparatuses, modules, or units, and are not used to limit the order or interdependence of functions performed by these apparatuses, modules, or units.

It should be noted that the modification of “one” mentioned in the present disclosure is illustrative rather than restrictive, and those skilled in the art should understand that unless the context clearly indicates otherwise, it should be understood as “one or more”.

The names of messages or information exchanged between multiple apparatuses in the implementations of the present disclosure are only for illustrative purposes, and are not intended to limit the scope of these messages or information.

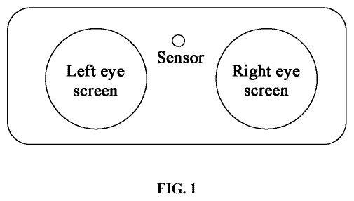

As shown in FIG. 1, which illustrates a schematic plan view of VR glasses, a circle of infrared LED lights (not shown in FIG. 1) is inlaid around the left eye screen and the right eye screen for face tracking (FT) and eye tracking (ET) camera exposure. Since the wavelength of the infrared LED light interferes with the field of view (FOV) and the wavelength of the sensor (i.e., the Psensor), the test data of the sensor is randomly distributed between 0 and the maximum value, which is completely unusable. Therefore, it is expected to provide an anti-interference method for the sensor.

FIG. 2 provides a flowchart of a control method of an electronic device according to an embodiment of the present disclosure. In some embodiments, the electronic device includes a sensor (i.e., a proximity sensor) configured to determine whether the electronic device is in a wearing state, a camera configured to perform face tracking and/or eye tracking, and an infrared lamp configured to expose the camera. In some embodiments, the infrared lamp configured to expose the camera is generally disposed around the screen corresponding to the left eye (i.e., the left eye screen) and/or around the screen corresponding to the right eye (i.e., the right eye screen). At this time, the infrared lamp may cause interference to the sensor, which in turn causes false wake-up or sleep of the electronic device, affecting the user experience.

In some embodiments, the control method of an electronic device of the present disclosure may include step S101, determining whether the camera is in an on state. In some embodiments, to avoid interference of the infrared lamp configured to expose the camera to the sensor, it is first determined whether the camera is in the on state. If the camera is in the on state, the infrared lamp configured to expose the camera may cause interference to the sensor, affecting normal operation of the sensor, thereby affecting the reliability and stability of the sensor.

In some embodiments, the method of the present disclosure may further include step S102: based on determining that the camera is in the off state, reading data of the sensor according to a preset period to determine whether the electronic device is in the wearing state. In some embodiments, when the camera is in the off state, the sensor will not be interfered by the infrared lamp configured to expose the camera, so that the data of the sensor can be read according to the preset period. Generally, the preset period is 5500 ms, that is, the data of the sensor is read every 500 ms to determine whether the electronic device is in the wearing state.

In some embodiments, the method of the present disclosure may further include step S103: based on determining that the camera is in the on state, triggering generation and reading of the data of the sensor using an interrupt signal. In some embodiments, if it is determined that the camera is in the on state, the infrared lamp configured to expose the camera at this time may cause interference to the sensor and cause misjudgment. By skipping reading the data of the sensor and instead triggering generation and reading of the data of the sensor using the interrupt signal, misjudgment caused by reading the data of the sensor at this time is avoided, and the accuracy of the data of the sensor is ensured.

According to the present disclosure, whether the camera is in the on state is determined, and the acquisition of the data of the sensor is determined based on the state of the camera, so that interference of the infrared lamp exposing the camera to the sensor can be avoided, the sensor can work reliably, and a good user experience is ensured while power consumption of the electronic device is saved.

In some embodiments, based on determining that the camera is in the on state, triggering the generation and reading of the data of the sensor using the interrupt signal includes: based on determining that the camera is in the on state, counting one continuous on state as one interruption, and performing interruption counting, where the interruption count is increased by 1 when an interruption is encountered, and based on determining that the interruption count reaches a preset number of times, clearing and restarting the interruption count; enabling the sensor at a falling edge of the Nth interruption, where N is a positive integer that is at least 1 less than the preset number of times; and reading data of the sensor at a falling edge of the (N+1)th interruption. In some embodiments, based on determining that the camera is in the on state, the infrared lamp configured to expose the camera may cause interference to the sensor. At this time, one continuous on state is counted as one interruption (for example, an interruption that usually lasts for 2 ms), and interruption counting is performed. Every time an interruption is identified, the interruption count is increased by 1. In some embodiments, the sensor is enabled at the falling edge of the Nth interruption, where N is a positive integer that is at least 1 less than the preset number of times, for example, N is 3. Then, the data of the sensor is read at the falling edge of the (N+1)th (for example, the fourth) interruption. Therefore, even when it is determined that the camera is in the on state, the data of the sensor can still be read by using the method of the present disclosure, without being interfered by the infrared lamp of the camera. In the present disclosure, the sampling and waiting time of the sensor are distributed in multiple flashing cycles of the infrared lamp to complete, so that the sensor can run reliably under the high-frequency operation of the infrared lamp, avoiding false wake-up of the electronic device, saving battery energy, and improving the user experience.

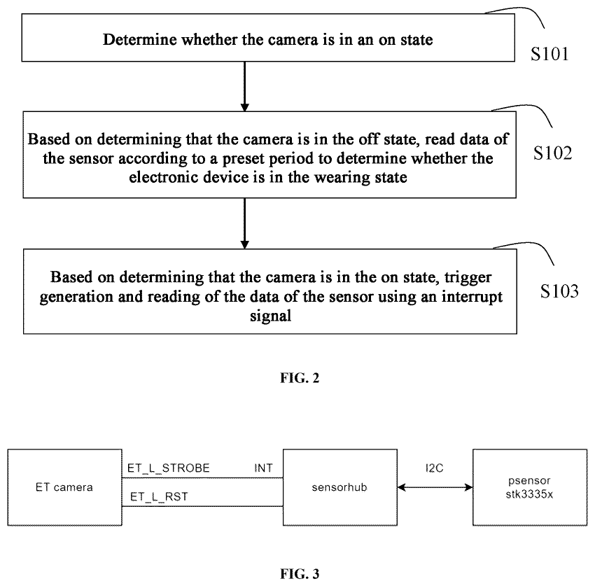

As shown in FIG. 3 and FIG. 5, taking the infrared lamp disposed around the left eye screen corresponding to the camera as an example, the strobe signal of the left eye camera (ET left camera) is connected to the sensorhub, and the polling mode and the interrupt mode are enabled at the same time. In the polling mode, the sensorhub reads data of the sensor according to a fixed period. Before reading, the state of the camera is determined first. If the camera is on, the data reading is skipped and returns directly; otherwise, normal data reading and processing are performed. If the camera is on, i.e. the infrared lamp is on, the sensorhub receives an interruption, and the data reading and processing are performed in the interrupt service program. If the infrared lamp is off, the interruption does not exist, the polling mode is still working, and the data reading and processing of the sensor are started.

In some embodiments, determining whether the camera is in the on state includes determining whether the camera is in the on state by reading an electrical signal of the camera. In some embodiments, it is determined whether the camera is on by reading a reset (RST) signal of the camera, so that the state does not need to be queried through an interface and a callback function with the camera, thereby realizing decoupling between the sensor and the camera.

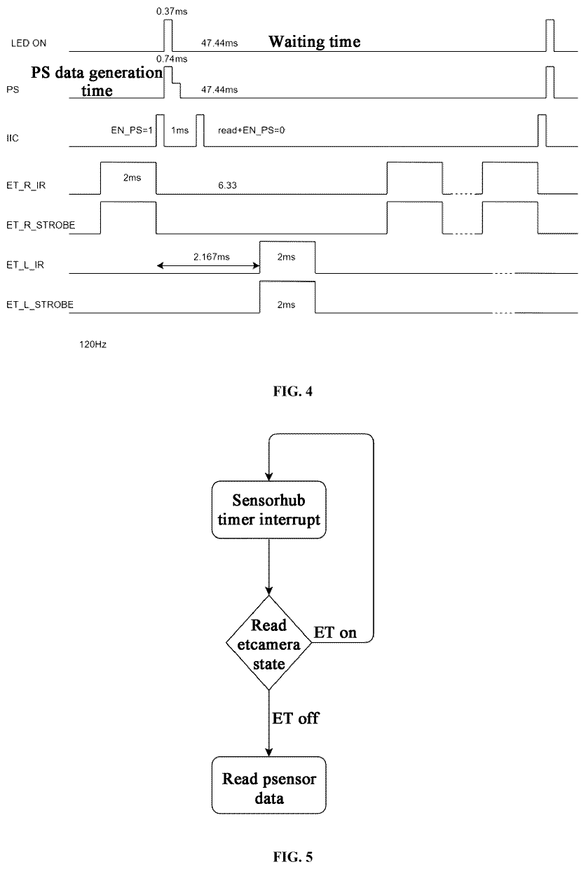

FIG. 4 illustrates a sequence diagram of some components of an electronic device according to an embodiment of the present disclosure, LED ON corresponds to a sequence diagram of the sensor, PS corresponds to a sequence diagram of sensor data generation, IIC corresponds to a sequence diagram of a reading signal, ET_R_IR corresponds to a sequence diagram of an infrared lamp of the right eye camera, ET_R_STROBE corresponds to a sequence diagram of a strobe signal of the right eye camera, ET_L_IR corresponds to a sequence diagram of an infrared lamp of the left eye camera, and ET_L_STROBE corresponds to a sequence diagram of a strobe signal of the left eye camera. As can be seen from the sequence diagram in FIG. 4, the infrared lamp has a maximum operating frequency of 120 Hz and the left and right eyes are out of phase. The sensor can only have a 2 ms time window for data collection, and the sampling period of the sensor is usually more than 40 ms (the smaller the waiting time, the larger the duty cycle and the higher the power consumption), which makes it impossible for the sensor to complete the collection during the turn-off time period (up to 2 ms) of an infrared lamp. Therefore, the present disclosure splits the enabling or waiting of the sensor to complete in multiple periods of the infrared lamp.

In some embodiments, the enabling time of the sensor is between 0.18 ms and 0.19 ms, and the execution time for reading the data of the sensor is between 160 μs and 180 μs. In this way, the collection function of the sensor is optimized, and the execution time is reduced, from an execution time of nearly 1 ms to about 170 μs, which greatly saves time for data collection. At the same time, the LED ON is set to a minimum of about 0.185 ms, so that it can be completed within 2 ms. It has been verified that the time from enabling the sensor to reading the data of the sensor is within 1.15 ms, which is quite far from 2 ms, and there is sufficient time margin.

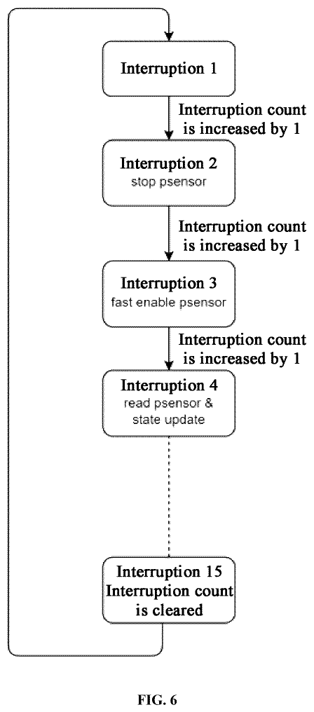

As shown in FIG. 6, in the interrupt service program, a number of interruptions is counted, the interruption count is increased by 1 when an interruption is identified, and when the interruption count reaches the preset number of times, the interruption count is cleared. In some embodiments, the preset number of times is between 8 and 20. If the preset number of times is too small, it is not conducive to meeting the sufficient waiting time (about 47 ms). If the preset number of times is too large, the power consumption of the electronic device will be reduced. It should be understood that what is illustrated in FIG. 6 is only a specific example and is not intended to limit. For example, although it is illustrated that the sensor is enabled at the falling edge of the third interruption and the data of the sensor is read at the falling edge of the fourth interruption, the sensor may also be enabled at the falling edge of the fifth interruption and the data of the sensor may be read at the falling edge of the sixth interruption, and so on. In addition, although it is illustrated that the interruption count is cleared after the 15th interruption, the interruption may also be cleared after the 10th interruption or the 20th interruption, for example.

In some embodiments, the sensor includes a device that emits infrared light. In some embodiments, the emitted infrared light encounters an obstacle and returns, and the return time can be used to determine the distance of the obstacle, so as to determine whether the electronic device is in the wearing state.

The method of the present disclosure eliminates interference of the infrared lamp exposing the camera to the sensor, ensures the correctness of the sensor data, ensures that the electronic device will not be falsely awakened, and improves the user experience while saving battery energy.

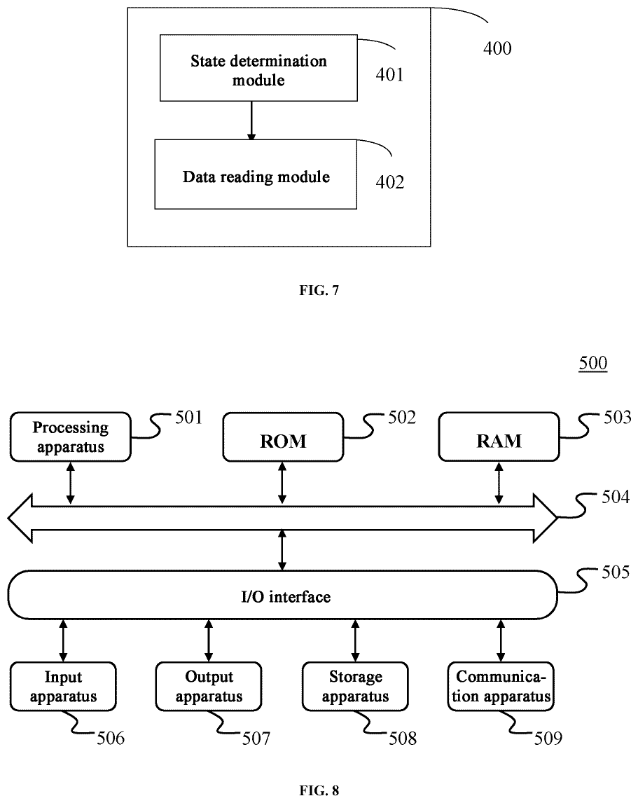

An embodiment of the present disclosure further provides a control apparatus 400 of an electronic device. FIG. 7 illustrates a control apparatus 400 of an electronic device according to some embodiments. The control apparatus 400 of an electronic device includes a state determination module 401 and a data reading module 402. In some embodiments, the electronic device includes a sensor configured to determine whether the electronic device is in a wearing state, a camera configured to perform face tracking and/or eye tracking, and an infrared lamp configured to expose the camera. In some embodiments, the state determination module 401 is configured to determine whether the camera is in an on state. In some embodiments, the data reading module 402 is configured to, based on determining that the camera is in an off state, read data of the sensor according to a preset period to determine whether the electronic device is in the wearing state. The data reading module 402 is further configured to, based on determining that the camera is in the on state, trigger generation and reading of the data of the sensor using an interrupt signal.

It should be understood that the content described with respect to the control method of an electronic device is also applicable to the control apparatus 400 of an electronic device here, and for the sake of simplicity, it is not described in detail here.

In some embodiments, the control apparatus further includes an interruption counting module configured to, based on determining that the camera is in the on state, count one continuous on state as one interruption, and perform interruption counting, where the interruption count is increased by 1 when an interruption is encountered, and based on determining that the interruption count reaches a preset number of times, clear and restart the interruption count; an enabling module configured to enable the sensor at a falling edge of an Nth interruption, where N is a positive integer that is at least 1 less than the preset number of times; and the data reading module is further configured to read data of the sensor at a falling edge of an (N+1)th interruption. In some embodiments, the enabling time of the sensor is between 0.18 ms and 0.19 ms, and the execution time for reading the data of the sensor is between 160 μs and 180 μs. In some embodiments, the preset number of times is between 8 and 20. In some embodiments, the sensor includes a device emitting infrared light. In some embodiments, the infrared lamp is disposed around the screen corresponding to the left eye or around the screen corresponding to the right eye. In some embodiments, determining whether the camera is in the on state includes: determining whether the camera is in the on state by reading an electrical signal of the camera.

In addition, the present disclosure further provides a terminal, including at least one memory and at least one processor, where the memory is configured to store program code, and the processor is configured to invoke the program code stored in the memory to perform the above-mentioned control method of an electronic device.

In addition, the present disclosure further provides a non-transitory computer-readable storage medium, where the computer storage medium stores program code, and the program code is configured to perform the above-mentioned control method of an electronic device.

Above, the control method and apparatus of an electronic device of the present disclosure are described based on embodiments and application examples. In addition, the present disclosure further provides a terminal and a storage medium, which are described below.

Referring to FIG. 8 below, which illustrates a schematic structural diagram of an electronic device (such as a terminal device or a server) 500 suitable for implementing an embodiment of the present disclosure. The terminal device in an embodiment of the present disclosure may include, but is not limited to, a mobile terminal such as a mobile phone, a laptop, a digital broadcast receiver, a PDA (personal digital assistant), a PAD (tablet computer), a PMP (portable multimedia player), a vehicle-mounted terminal (such as a vehicle-mounted navigation terminal), or the like, and a fixed terminal such as a digital TV, a desktop computer, or the like. The electronic device shown in FIG. 8 is merely an example, and should not pose any limitation to the functions and the range of use of the embodiments of the present disclosure.

As shown in FIG. 8, the electronic device 500 may include a processing apparatus (such as a central processing unit, a graphics processing unit, etc.) 501, which may perform various appropriate actions and processes according to a program stored in a read-only memory (ROM) 502 or a program loaded from a storage apparatus 508 into a random access memory (RAM) 503. The RAM 503 also stores various programs and data required for the operation of the electronic device 500. The processing apparatus 501, the ROM 502, and the RAM 503 are connected to each other through a bus 504. An input/output (I/O) interface 505 is also connected to the bus 504.

Generally, the following apparatus may be connected to the I/O interface 505: an input apparatus 506 including, for example, a touch screen, a touchpad, a keyboard, a mouse, a camera, a microphone, an accelerometer, a gyroscope, or the like; an output apparatus 507 including, for example, a liquid crystal display (LCD), a speaker, a vibrator, or the like; a storage apparatus 508 including, for example, a magnetic tape, a hard disk, or the like; and a communication apparatus 509. The communication apparatus 509 may allow the electronic device 500 to perform wireless or wired communication with other devices to exchange data. Although FIG. 8 shows the electronic device 500 having various apparatuses, it should be understood that not all of the illustrated apparatuses are required to be implemented or provided. More or fewer apparatuses may alternatively be implemented or provided.

In particular, according to an embodiment of the present disclosure, the process described above with reference to the flowchart may be implemented as a computer software program. For example, an embodiment of the present disclosure includes a computer program product, which includes a computer program carried on a computer readable medium, and the computer program includes program code for executing the method shown in the flowchart. In such an embodiment, the computer program may be downloaded and installed from a network through the communication apparatus 509, or installed from the storage apparatus 508, or installed from the ROM 502. When the computer program is executed by the processing apparatus 501, the above-mentioned functions defined in the method of the embodiment of the present disclosure are executed.

It should be noted that the above-mentioned computer-readable medium in the present disclosure may be a computer-readable signal medium or a computer-readable storage medium or any combination of the above two. The computer-readable storage medium may be, for example, but not limited to, an electrical, magnetic, optical, electromagnetic, infrared, or semiconductor system, apparatus, or device, or any combination of the above. More specific examples of the computer-readable storage medium may include, but are not limited to: an electrical connection with one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, the computer-readable storage medium may be any tangible medium that contains or stores a program, and the program may be used by or in combination with an instruction execution system, apparatus, or device. In the present disclosure, the computer-readable signal medium may include a data signal propagated in a baseband or as a part of a carrier wave, and computer-readable program code is carried therein. This propagated data signal may take many forms, including but not limited to electromagnetic signals, optical signals, or any suitable combination of the above. The computer-readable signal medium may also be any computer-readable medium other than the computer-readable storage medium. The computer-readable signal medium may send, propagate, or transmit a program for use by or in combination with an instruction execution system, apparatus, or device. The program code contained on the computer-readable medium may be transmitted by any suitable medium, including but not limited to: wire, optical cable, RF (radio frequency), etc., or any suitable combination of the above.

In some implementations, the client and the server may communicate using any currently known or future-developed network protocol such as HTTP (HyperText Transfer Protocol), and may interconnect with digital data communication (for example, communication network) in any form or medium. Examples of communication networks include local area networks (“LAN”), wide area networks (“WAN”), international network (for example, the Internet), and end-to-end networks (for example, ad hoc end-to-end networks), as well as any currently known or future-developed networks.

The above computer-readable medium may be included in the above electronic device; or may exist alone without being assembled into the electronic device.

The above computer-readable medium carries one or more program segments, and when the above one or more program segments are executed by the electronic device, the electronic device is caused to execute the above method of the present disclosure.

Computer program code for performing the operations of the present disclosure may be written in one or more programming languages or a combination thereof. The above programming languages include object-oriented programming languages such as Java, Smalltalk, C++, and also include conventional procedural programming languages such as “C” language or similar programming languages. The program code can be executed completely on the user's computer, partially on the user's computer, as an independent software package, partially on the user's computer and partially on a remote computer, or completely on a remote computer or server. In the case of involving a remote computer, the remote computer can be connected to the user computer through any kind of network, including a local area network (LAN) or a wide area network (WAN); or, it can be connected to an external computer (for example, connected through the Internet using an Internet service provider).

The flowcharts and block diagrams in the drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the drawings. For example, two blocks shown in succession may, in fact, can be executed substantially concurrently, or the two blocks may sometimes be executed in the reverse order, depending upon the functionality involved. It should also be noted that, each block of the block diagrams and and/or flowchart illustrations, and combinations of blocks in the block diagrams and/or flow chart illustrations, can be implemented by special purpose hardware-based systems that perform the specified functions or acts, or combinations of special purpose hardware and computer instructions.

The units involved in the embodiments of the present disclosure may be implemented by software or hardware. The name of a unit does not constitute a limitation on the unit itself under certain circumstances.

The functions described herein above may be performed, at least in part, by one or more hardware logic components. For example, without limitation, exemplary types of hardware logic components that can be used include: field programmable gate array (FPGA), application specific integrated circuit (ASIC), application specific standard product (ASSP), system on chip (SOC), complex programmable logic device (CPLD), etc.

In the context of the present disclosure, the machine-readable medium may be a tangible medium that may contain or store a program for use by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above. More specific examples of machine-readable storage media may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above.

According to one or more embodiments of the present disclosure, a control method of an electronic device is provided, the electronic device includes a sensor configured to determine whether the electronic device is in a wearing state, a camera configured to perform at least one of face tracking or eye tracking, and an infrared lamp configured to expose the camera, and the control method of an electronic device includes: determining whether the camera is in an on state; based on determining that the camera is in an off state, reading data of the sensor according to a preset period to determine whether the electronic device is in the wearing state; and based on determining that the camera is in the on state, triggering generation and reading of the data of the sensor using an interrupt signal.

According to one or more embodiments of the present disclosure, based on determining that the camera is in the on state, triggering the generation and reading of the data of the sensor using the interrupt signal includes: based on determining that the camera is in the on state, counting one continuous on state as one interruption, and performing interruption counting, where the interruption count is increased by 1 when an interruption is encountered, and based on determining that the interruption count reaches a preset number of times, clearing and restarting the interruption count; enabling the sensor at a falling edge of an Nth interruption, where N is a positive integer that is at least 1 less than the preset number of times; and reading data of the sensor at a falling edge of an (N+1)th interruption.

According to one or more embodiments of the present disclosure, an enabling time of the sensor is between 0.18 ms and 0.19 ms, and an execution time for reading the data of the sensor is between 160 μs and 180 μs.

According to one or more embodiments of the present disclosure, the preset number of times is between 8 and 20.

According to one or more embodiments of the present disclosure, the sensor includes a device emitting infrared light.

According to one or more embodiments of the present disclosure, the infrared lamp is disposed around a screen corresponding to a left eye or around a screen corresponding to a right eye.

According to one or more embodiments of the present disclosure, determining whether the camera is in the on state includes determining whether the camera is in the on state by reading an electrical signal of the camera.

According to one or more embodiments of the present disclosure, a control apparatus of an electronic device is provided, the electronic device includes a sensor configured to determine whether the electronic device is in a wearing state, a camera configured to perform face tracking and/or eye tracking, and an infrared lamp configured to expose the camera, and the control apparatus of an electronic device includes: a state determination module configured to determine whether the camera is in an on state; a data reading module configured to, based on determining that the camera is in an off state, read data of the sensor according to a preset period to determine whether the electronic device is in the wearing state; and the data reading module is further configured to, based on determining that the camera is in the on state, trigger generation and reading of the data of the sensor using an interrupt signal.

According to one or more embodiments of the present disclosure, a terminal is provided, including: at least one memory and at least one processor, where the at least one memory is configured to store program code, and the at least one processor is configured to invoke the program code stored in the at least one memory to perform the method according to any one of the above items.

According to one or more embodiments of the present disclosure, a storage medium is provided, which is configured to store program code, and the program code is configured to perform the above-mentioned method.

The foregoing description is only preferred embodiments of the present disclosure and an explanation of the applied technical principles. Those skilled in the art should understand that the scope of disclosure involved in the present disclosure is not limited to the technical solutions formed by the specific combination of the above-mentioned technical features, but also covers other technical solutions formed by any combination of the above-mentioned technical features or their equivalent features without departing from the above-mentioned disclosed concept, for example, a technical solution formed by the replacement of the above-mentioned features with technical features with similar functions disclosed in the present disclosure (but not limited to).

In addition, although the operations are described in a specific order, this should not be understood as requiring these operations to be performed in the specific order shown or in a sequential order. Under certain circumstances, multitasking and parallel processing may be advantageous. Similarly, although several specific implementation details are included in the above discussion, these should not be construed as limiting the scope of the present disclosure. Certain features that are described in the context of separate embodiments can also be implemented in combination in a single embodiment. Conversely, various features that are described in the context of a single embodiment can also be implemented in multiple embodiments separately or in any suitable sub-combination.

Although the present subject matter has been described in a language specific to structural features and/or method logical actions, it should be understood that the subject matter defined in the appended claims is not necessarily limited to the specific features or actions described above. On the contrary, the specific features and actions described above are only exemplary forms for implementing the claims.

I/We claim:

1. A control method of an electronic device comprising a sensor configured to determine whether the electronic device is in a wearing state, a camera configured to perform at least one of face tracking or eye tracking, and an infrared lamp configured to expose the camera, the control method comprising:
determining whether the camera is in an on state:
based on determining that the camera is in an off state, reading data of the sensor according to a preset period to determine whether the electronic device is in the wearing state: and
based on determining that the camera is in the on state, triggering generation and reading of the data of the sensor using an interrupt signal.

2. The control method of claim 1, wherein based on determining that the camera is in the on state, triggering generation and reading of the data of the sensor using an interrupt signal comprises:
based on determining that the camera is in the on state, counting one continuous on state as one interruption, and performing interruption counting, wherein the interruption count is increased by 1 when an interruption is encountered, and based on determining that the interruption count reaches a preset number of times, clearing and restarting the interruption count:
enabling the sensor at a falling edge of an Nth interruption, wherein N is a positive integer that is at least 1 less than the preset number of times; and
reading data of the sensor at a falling edge of an (N+1)th interruption.

3. The control method of claim 2, wherein an enabling time of the sensor is between 0.18 ms and 0.19 ms, and an execution time for reading the data of the sensor is between 160 μs and 180 μs.

4. The control method of claim 2, wherein the preset number of times is between 8 and 20.

5. The control method of claim 1, wherein the sensor comprises a device emitting infrared light.

6. The control method of claim 1, wherein the infrared lamp is disposed around a screen corresponding to a left eye or around a screen corresponding to a right eye.

7. The control method of claim 1, wherein determining whether the camera is in the on state comprises:
determining whether the camera is in the on state by reading an electrical signal of the camera.

8. A terminal comprising:
at least one memory and at least one processor,
wherein the at least one memory is configured to store program code, and the at least one processor is configured to invoke the program code stored in the at least one memory to perform a control method of an electronic device, wherein the electronic device comprises a sensor configured to determine whether the electronic device is in a wearing state, a camera configured to perform at least one of face tracking or eye tracking, and an infrared lamp configured to expose the camera, and wherein the at least one processor is configured to cause the terminal to:
determine whether the camera is in an on state:
based on determining that the camera is in an off state, read data of the sensor according to a preset period to determine whether the electronic device is in the wearing state; and
based on determining that the camera is in the on state, trigger generation and reading of the data of the sensor using an interrupt signal.

9. The terminal of claim 8, wherein the at least one processor is configured to cause the terminal to:
based on determining that the camera is in the on state, count one continuous on state as one interruption, and performing interruption counting, wherein the interruption count is increased by 1 when an interruption is encountered, and based on determining that the interruption count reaches a preset number of times, clear and restart the interruption count:
enable the sensor at a falling edge of an Nth interruption, wherein N is a positive integer that is at least 1 less than the preset number of times; and
read data of the sensor at a falling edge of an (N+1)th interruption.

10. The terminal of claim 9, wherein an enabling time of the sensor is between 0.18 ms and 0.19 ms, and an execution time for reading the data of the sensor is between 160 μs and 180 μs.

11. The terminal of claim 9, wherein the preset number of times is between 8 and 20.

12. The terminal of claim 8, wherein the sensor comprises a device emitting infrared light.

13. The terminal of claim 8, wherein the infrared lamp is disposed around a screen corresponding to a left eye or around a screen corresponding to a right eye.

14. The terminal of claim 8, wherein the at least one processor is configured to cause the terminal to:
determine whether the camera is in the on state by reading an electrical signal of the camera.

15. A non-transitory computer-readable storage medium having stored thereon a computer program that, when executed by a processor, implements a control method of an electronic device, wherein the electronic device comprises a sensor configured to determine whether the electronic device is in a wearing state, a camera configured to perform at least one of face tracking or eye tracking, and an infrared lamp configured to expose the camera, and wherein the control method comprises:
determining whether the camera is in an on state:
based on determining that the camera is in an off state, reading data of the sensor according to a preset period to determine whether the electronic device is in the wearing state; and
based on determining that the camera is in the on state, triggering generation and reading of the data of the sensor using an interrupt signal.

16. The non-transitory computer-readable storage medium of claim 15, wherein the control method comprises:
based on determining that the camera is in the on state, counting one continuous on state as one interruption, and performing interruption counting, wherein the interruption count is increased by 1 when an interruption is encountered, and based on determining that the interruption count reaches a preset number of times, clearing and restarting the interruption count:
enabling the sensor at a falling edge of an Nth interruption, wherein N is a positive integer that is at least 1 less than the preset number of times; and
reading data of the sensor at a falling edge of an (N+1)th interruption.

17. The non-transitory computer-readable storage medium of claim 16, wherein an enabling time of the sensor is between 0.18 ms and 0.19 ms, and an execution time for reading the data of the sensor is between 160 μs and 180 μs, and wherein the preset number of times is between 8 and 20.

18. The non-transitory computer-readable storage medium of claim 15, wherein the sensor comprises a device emitting infrared light.

19. The non-transitory computer-readable storage medium of claim 15, wherein the infrared lamp is disposed around a screen corresponding to a left eye or around a screen corresponding to a right eye.

20. The non-transitory computer-readable storage medium of claim 15, wherein the control method comprises:
determining whether the camera is in the on state by reading an electrical signal of the camera.
